(19) United States
(12) Patent Application Publication
(10) Pub. No.: US 2005/0041097 A1
(43) Pub. Date: Feb. 24, 2005

(54) Non-medical videoscope

(76) Inventors: Robert M. Bernstein, Culver City, CA (US); William I. Berks, Manhattan Beach, CA (US)

Correspondence Address: Daniel H. Golub, 1701 Market Street, Philadelphia, PA, 19103, US

(21) Appl. No.: 10/731,329

(22) Filed: Dec. 9, 2003

Related U.S. Application Data
(60) Provisional application No. 60/496,438, filed on Aug. 19, 2003.

(51) Int. Cl. H04N 7/18

(52) U.S. Cl. 348/82; 348/61; 348/84; 348/85

(57) ABSTRACT

A videoscope includes a sensor end having an image detector and at least one sensor selected from the group consisting of an eddy current sensor and an ultrasonic sensor, a handle; and an elongated arm that comprises a conduit that connects the sensor end to the handle. The conduit houses a link that transmits image information from the image detector through the conduit, and the conduit further houses at least first and second working channels that extend from the sensor end to the handle. Fluid injected at a handle end of the conduit passes through the first working channel, out the sensor end, and onto the surface under examination. The second working channel contains the eddy current or ultrasonic sensor and passes their signals through the conduit.

This application claims the benefit of U.S. provisional application No. 60/496,438 incorporated herein by reference in its entirety.

### FIELD OF THE INVENTION

The field of the invention is videoscopes.

### BACKGROUND OF THE INVENTION

A videoscope has an image detecting element (a CCD, for example) at a distal end (the “sensor end”) of an elongated arm (rigid or flexible) wherein the arm is coupled to a handle and signals from the image detecting element are transmitted from the image detecting element and along the arm towards the handle by one or more electrical conductors. The signals are subsequently transmitted to a display, and an image generated from the signals is viewed by a videoscope operator. Videoscopes will typically also comprise one or more optical fibers extending along the arm between the handle and the sensor end. Such optical fibers are used to transmit light to the sensor end and to provide light for illuminating the field of view of the image detecting element.

### SUMMARY OF THE INVENTION

The present invention is directed to an improved videoscope based inspection tool that has at least two working channels extending along the arm wherein one channel (a “sensor/tool channel”) is adapted to permit a non-destructive testing (NDT) sensor or a tool to be positioned at the distal end, and a second channel (a “fluid delivery” channel) is adapted to guide a fluid (a gas or liquid) to the sensor end. Such an inspection tool permits the use of miniature NDT probes and remediation tools in remote and normally inaccessible areas such as the internal areas of an engine, metal structures within the walls of a building, remote sections of a pipe, and the like.

Combining the working channels with an image detecting element allows an operator to view the position and/or operation of any tool passing through the sensor/tool channel as well as the placement of any fluid passing through the fluid delivery channel. In some instances any lens system used to focus a signal on the image detecting element could be directed toward where a tool passing through the working channel would be during its operation.

In one embodiment, the videoscope includes a sensor end having an image detector and at least one sensor selected from the group consisting of an eddy current sensor and an ultrasonic sensor; a handle; and an elongated arm that comprises a conduit that connects the sensor end to the handle. The conduit houses a link that transmits image information from the image detector through the conduit, and the conduit further houses at least first and second working channels that extend from the sensor end to the handle. Fluid injected at a handle end of the conduit passes through the first working channel, out the sensor end, and onto the surface or object under examination. The second working channel contains the eddy current or ultrasonic sensor and transmits their signals through the conduit.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is a perspective view of a videoscope embodying the invention.

### DETAILED DESCRIPTION

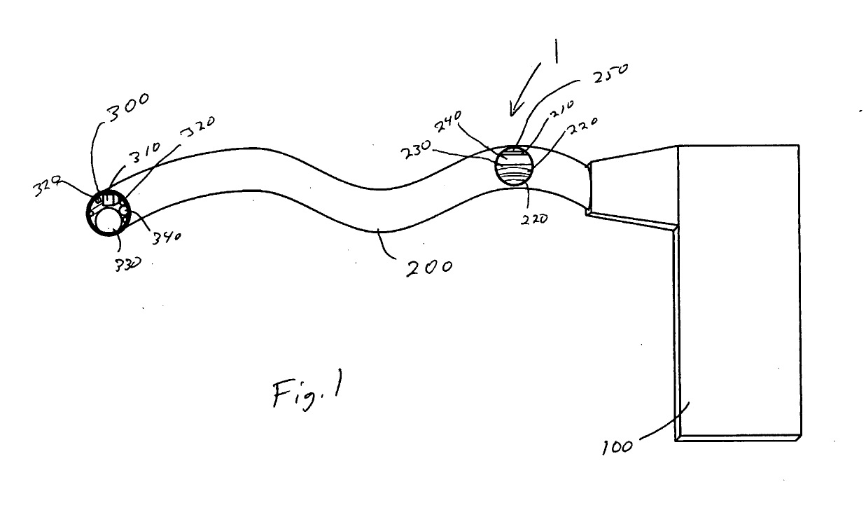

As shown in FIG. 1, a videoscope 1 comprises a handle 100 and an arm 200 wherein arm 200 comprises a sensor end 300. Sensor end 300 comprises an image detecting element 310, optical fiber ends 320, and the ends of working channels 330 and 340. Fibers 220 extend along the length of arm 200, as do working channels 230 and 240, and conductors 210. Conductors 210 transmit signals to and from element 310. Arm 200 may also comprise one or more steering cables 250 required for distal end articulation. The portion of arm 200 that is coupled to handle 100 may be referred to as the handle end, and the sensor end 300 of the arm may be referred to as the distal end.

As can be seen, FIG. 1 depicts an improved videoscope based inspection tool 1 that has at least two working channels 330 and 340 extending along the arm wherein one channel (a “sensor/tool channel”) is adapted to permit a non-destructive testing (NDT) sensor or a tool to be positioned at the distal end, and a second channel (a “fluid delivery” channel) is adapted to guide a fluid (a gas or liquid) to the sensor end. Such an inspection tool permits the use of miniature NDT probes and remediation tools in remote and normally inaccessible areas such as the internal areas of an engine, metal structures within the walls of a building, remote sections of a pipe, and the like.

It is contemplated that any tool or sensor having an appropriate size could be positioned near the sensor end using the sensor/tool channel. However, it is contemplated that eddy current, ultraviolet, and ultrasound sensors may prove particularly advantageous, and can be manufactured to pass through the sensor/tool channel while maintaining an adequate signal-to-noise ratio.

It is contemplated that transmitting a fluid to the sensor end through the fluid delivery channel would be particularly advantageous if the fluid was one of: water (or other coupler) to enhance the output of an ultrasound sensor positioned via the sensor/tool channel; or a dye penetrant (or air to speed the drying of the dye penetrant) to be used with a ultraviolet (UV) light source and detector to examine the dye penetrant after it has been applied to a surface. However, any fluid that serves a desired purpose at the sensor end of the tool could be transported to that end via the fluid delivery channel. Fluid from the fluid delivery channel may also be used to mark a suspicious area (e.g., an area where a crack may be present) for further examination. In one embodiment (not shown), a syringe located on or near handle 100 is used to inject fluid through the fluid delivery channel and onto the surface being analyzed.

The actual materials used in the construction of videoscope 1 may vary between different types of videoscopes, as may the sizes and dimensions of its various components.

Arm 200 may be rigid or flexible. If flexible, it is advantageous to provide it with a steering mechanism such as cables 250 in order to be able to change the position of the sensor end 300 from handle 100. Less preferred embodiments may use a different type of steering mechanism.

The working channels, optical fibers, and conductors are preferred to be positioned within arm 200 in order to protect them and to make insertion of arm 200 into small openings easier. However, in less preferred embodiments, one or more elements of videoscope 1 that extend from the handle to a position at or near sensor end 300 may be positioned on the outside of arm 200, or may simply be adjacent to arm 200.

Image detecting element 310 is preferably a CCD (charge coupled device) detector, square or rectangular in shape, and sized to fit in an 11 or 12 mm envelope. However, element 310 may comprise and device or combination of devices suitable for detecting and transmitting images of surfaces and/or objects positioned near the sensor end of videoscope 1. In less preferred embodiments, an image may be transmitted via an optical fiber, or element 310 may be something other than a CCD.

It is contemplated that an inspection tool as described herein may comprise multiple image detecting elements. In such an instance, the use of multiple elements may be used to provide a larger field of view and/or different viewing angles. If multiple image detecting elements are used, one or more elements may be dedicated to viewing a particular portion of the tool, or to a surface being inspected and/or manipulated.

### Example #1

It is contemplated that videoscopes having delivery channels as described herein may be used in conjunction with an ultrasound sensor being positioned through use of the videoscope. In such an instance, an ultrasound sensor could be passed through an arm of the videoscope, and the videoscope used first to identify a location where the sensor is to be positioned, then to transmit a fluid such as water to that location, and then to position the sensor. Ideally, fluid transmission, and positioning of the ultrasound sensor would all be done while using the videoscope to view the location where the sensor is being positioned.

### Example #2

It is contemplated that videoscopes having delivery channels as described herein may also be used to mark a suspicious area for further examination. The use of a videoscope to do such marking allows objects or portions of objects that are not readily accessible to be marked, and allows them to be marked without having to stop viewing the area through the videoscope. As such, a method of using a videoscope comprising a fluid delivery channel may comprise one or more of the following steps: using a videoscope comprising a fluid delivery channel to examine an object or a portion of an object and to identify a portion of the object that is to be further examined, replaced, and/or repaired; while viewing the portion of the object to be marked through the videoscope, causing fluid to flow through an arm of the videoscope and onto or adjacent to the identified portion of the object; subsequently removing and/or disassembling the object and locating the identified portion of the object. If, for example, the object is an aircraft engine having internal assemblies that are only visible with disassembling the engine, through the use of access ports and a videoscope, one could use such a port and the videoscope to identify a potential problem within the engine, to mark that spot using fluid delivered via the videoscope, to remove the scope from the access port and thereby temporarily losing visibility to the marked portion, and then removing and/or partially disassembling the engine to regain visibility to the marked portion. In contrast, prior methods would typically require either removal and/or disassembly of the engine for inspection, and having to re-locate the area of concern after such removal and/or disassembly.

Thus, specific embodiments and applications of videoscopes having fluid delivery channels have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1. A videoscope for examining a surface, said videoscope comprising:
(a) a sensor end having an image detector and at least one sensor selected from the group consisting of an eddy current sensor and an ultrasonic sensor;
(b) a handle; and
(c) an elongated arm that comprises a conduit that connects the sensor end to the handle;
wherein the conduit houses a link that transmits image information from the image detector through the conduit; and
wherein the conduit further houses at least first and second working channels that extend from the sensor end to the handle;
wherein fluid injected at a handle end of the conduit passes through the first working channel, out the sensor end, and onto the surface under examination; and
wherein the second working channel transmits signals from the eddy current or ultrasonic sensor that is passed through the conduit.

2. The videoscope of claim 1 further comprising at least one light source positioned at or near the sensor end.

3. The videoscope of claim 2 further comprising at least one optical fiber adapted to transmit light to the at least one light source, wherein the at least one optical fiber is positioned within the arm and extends along the length of the arm.

4. The videoscope of claim 3 wherein the image detecting element is a CCD (charge coupled device), and the at least one transmission path for transmitting signals from the CCD comprises at least one electrical conductor.

5. A method of using a videoscope comprising:
using the videoscope to identify a portion of an assembly to which fluid is to be applied; and
using the videoscope to deliver and apply fluid to the identified portion.

6. The method of claim 5 wherein the fluid delivered is water or a dye.

7. The method of claim 5 further comprising using the videoscope to place a sensor in contact with the fluid applied to the identified portion of the assembly.

8. The method of claim 7 wherein the sensor is an ultrasound sensor, the fluid delivered is water, and the method further comprises using the ultrasound sensor to examine the portion of the assembly to which fluid was applied.

9. The method of claim 5 wherein the fluid is a dye or other marking fluid and the method comprises removing a portion of the assembly limiting access to the marked portion of the assembly, and then using the applied marking fluid to re-identify the marked portion of the assembly.

10. A videoscope comprising an elongated arm having at least two working channels.
